(19) United States
(12) Patent Application Publication
(10) Pub. No.: US 2003/0231246 A1
(43) Pub. Date: Dec. 18, 2003

(54) Digital photofinishing system utilizing user preference profiles

(75) Inventors: Edward B. Gindele, Rochester, NY (US); Paul B. Gilman, Penfield, NY (US); Robert T. Gray, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/174,088

(22) Filed: Jun. 18, 2002

(51) Int. Cl. H04N 5/228

(52) U.S. Cl. 348/222.1

(57) ABSTRACT

A method for processing a digital image in order to provide an enhanced digital image provides an image processing path including a plurality of image processing modules designed to enhance the appearance of the digital image, wherein the processing effect of each image processing module is controlled by one or more processing control parameters. Using the same image processing path, a test image is processed. A plurality of available image renditions are generated from the test image by varying one or more of the processing control parameters to control the image processing path of the test image. The plurality of available image renditions are then presented to the user for viewing and selection, whereby the selection of a particular image rendition determines the selection of a particular value of one or more processing control parameters that relate to a preference of the user. A user preference profile is generated by storing the selected values of the processing control parameters relating to the preference of the user, and an enhanced digital image is produced by processing the digital image according to a user preference by using the user preference profile to customize the image processing path, and thereby produce the enhanced digital image from the digital image.

### FIELD OF THE INVENTION

The present invention relates to a digital photofinishing system including a plurality of image processing modules employed within an image processing path for enhancement and manipulation of digital images.

### BACKGROUND OF THE INVENTION

The Kodak Premier™ Image Enhancement System introduced in 1990 was a digital imaging application designed for the purposes of digitally manipulating digital images derived from a photographic film transparency material. In the Kodak Premier™ system, an original photographic film transparency material was scanned to produce a digital image. The user then manipulated the digital image to change one or more image characteristics including color balance and contrast. The manipulated digital image was then used to make an output photographic film transparency in the same form as the original but with the changed image characteristics. The user would bring up on an electronic display device a digital image derived from the original photographic film transparency. The user would then have a variety of controls available which would directly change one or more image processing parameters. As part of the image manipulation digital image processing procedures, the Kodak Premier™ system allowed the user to record the image processing parameters that were used to manipulate the digital image. The record of image processing parameters was stored on computer disk and could be retrieved for later processing. In addition, the retrieved image processing parameters, which were derived by manipulating a first digital image, could be applied to other digital images to produce a similar desired image look.

Other more current examples of digital imaging software packages, such as Adobe PhotoShop™ and Hewlett Packard DeskPro™, allow a user of the software to record image processing parameter(s) derived from manipulating a first digital image to be used to affect a second digital image. While these methods of saving image processing parameters for use with other digital images are powerful, they are also cumbersome due to the fact that a burden is placed on the user to learn how to use the particular image editing software package to advantage.

Traditionally, photographers using analog imaging equipment, such as photographic enlargers, would print variations of a photographic film transparency onto photographic paper using different exposure settings for the photographic enlarger. After viewing the resultant photographic prints, the photographer would then choose the optimum setting and make a final print. Digital imaging software applications have used this basic idea to present a user with multiple image renditions of a digital image viewed on an electronic display device. The user views the multiple images and selects the most pleasing. After the user has made a selection, the software application repeats the process with multiple image renditions of a different digital image. Thus, one by one the user is allowed to select the most pleasing image rendition of a manipulated digital image. While these applications are useful and intuitive for an uninitiated user to master, they are also slow and tedious to use due to the image by image presentation method employed.

In U.S. Pat. No. 5,300,974, Stephenson discloses a system that provides camera users with the ability to select color balance preferences for the reproduction of scene images captured on film. The system disclosed by Stephenson includes a user interactive station for displaying digital test images, derived from at least one predetermined scene type, which have been manipulated to have progressively different color balance characteristics. The user selects a displayed test image that he or she prefers and the system records the user's preference selection on a storage medium for transfer with the user's film to a photofinishing operation. In one embodiment, the user inserts a photographic film cartridge capable of recording additional information magnetically onto the photographic film into a specialized device for recording. The user-selected color balance information is then recorded magnetically onto the photographic film. The analog photofinishing system then retrieves and uses the user-selected color balance information from the film to make photographic prints for the user. In addition, the user-selected color balance information can be stored on a separate storage medium, such as a memory card, for direct transfer to the photofinisher.

While the method disclosed by Stephenson provides a means for customizing user color balance preferences for analog imaging systems, Stephenson is silent as to any extension of the method for a complicated digital imaging system. One problem is the complexity of the digital imaging system, wherein many different types of corrections can be made, including some that have an interactive effect upon others.

In commonly-assigned, copending U.S. patent application Ser. No. 09/742,553, entitled “Plurality of Picture Appearance Choices from a Color Photographic Recording Material Intended for Scanning” and filed Dec. 20, 2000 in the names of Sowinski et al, and Ser. No. 09/592,816, entitled “An Image Processing and Manipulation System” and filed Jun. 13, 2000 in the names of Szajewski et al (and which was published as European Patent Application EP 1 182 858 A2 on Feb. 27, 2002), the applicants disclose a method for a digital photofinishing system that extends the analog technology disclosed by Stephenson in U.S. Pat. No. 5,300,974 to a digital imaging system. The methods disclosed by these applications include processing images derived from scan-only photographic recording material and images derived from digital cameras. As disclosed by these applications, a selection of available appearances are presented to a user of the system as photographic prints displayed on a mailer, a brochure or an electronic device. Such image appearances include accurate color reproduction, portraiture, brilliant color, black-and-white, old fashioned sepia tones, selected levels of color intensity, selected levels of contrast, selected levels of detail reproduction, and selected levels of grain or noise. The user then selects from among these appearances and the images are rendered accordingly. The drawback of this system is that it fails to precisely isolate the effect of varying a single attribute on user preference, with other attributes contributing but held in a constant state.

In commonly-assigned, copending U.S. patent application Ser. No 09/549,356, entitled “Customizing a Digital Camera” and filed Apr. 14, 2000 in the names of Prabhu et al, (and which was published as European Patent Publication EP 1 058 450 A1 on Dec. 12, 2000), the applicants disclose a method for customizing the image processing operations performed by a digital camera. The camera customization software permits two or more users to customize the feature set (e.g., resolution, color correction, tone correction, sharpness and compression) of the digital camera and to store the corresponding firmware settings in the camera memory. When the camera is powered on, a list of users is displayed and the user selects their name using the camera interface. In response, the camera processor uses the appropriate firmware settings to provide the feature set for that particular user. During the process of initially establishing the feature set, the camera customization software may provide the user with sets of digital images, for example, three images at a time, and asks the user to choose which of the three images is preferred out of each set. The images have noticeable differences in flesh tones, sharpness, contrast, and other image attributes. While this application depicts multiple image renditions for a single processing control parameter, it does not precisely isolate the effect of varying a single attribute on user preference, with other attributes contributing but held in a constant state.

What is needed is a digital system for providing precise selection of user preferences for particular implementations of image processing modules. As mentioned above, none of the systems mentioned above precisely isolate the effect of varying a single attribute on user preference, particularly with other attributes contributing but held in a constant state.

### SUMMARY OF THE INVENTION

It is an object of the invention to precisely isolate the effect of varying a single attribute on user preference, with other attributes contributing but held in a constant state.

It is a further object of the invention to provide a means for precisely selecting a user's preference for particular implementations of image processing modules, including without limitation modules for controlling image sharpness, noise removal, overall contrast, and color contrast, by presenting the user with multiple choices as variants of a single image quality attribute.

It is another object of the invention to provide a means for customizing photographic prints based on the physical size of the photographic prints requested, and the type of image capture device used to produce the source digital images.

The present invention is directed to overcoming one or more of the problems set forth above. In particular, the invention departs from the prior art by assuring that the test images used to ascertain preference are processed through the same image processing path as the final enhanced images, and, more specifically, are processed in the same image processing modules to isolate the effect of varying a single attribute on user preference, with other attributes contributing but held in a constant state.

Briefly summarized, according to one aspect of the present invention, the invention resides in a method for processing a digital image in order to provide an enhanced digital image comprising the steps of: a) providing an image processing path including a plurality of image processing modules designed to enhance the appearance of the digital image, wherein the processing effect of each image processing module is controlled by one or more processing control parameters; b) using the image processing path to process a test image; c) generating a plurality of available image renditions from the test image by varying one or more of the processing control parameters to control the image processing path of the test image; d) presenting the plurality of available image renditions to the user for viewing and selection by the user, whereby the selection of a particular image rendition determines the selection of a particular value of one or more processing control parameters that relate to a preference of the user; e) generating a user preference profile by storing the selected values of the processing control parameters relating to the preference of the user; and f) processing the digital image according to a user preference by using the user preference profile to customize the image processing path and to thereby produce an enhanced digital image from the digital image.

The advantage of the invention is that, by assuring that the test images used to ascertain preference are processed through the same image processing path as the final enhanced images, the test image renditions more effectively isolate the effect of varying a single attribute on user preference, thereby providing greater assurance that the final enhanced image will reflect the user preference noted in the chosen image renditions in the first place.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a block diagram showing a digital photofinishing system suitable for practicing the present invention.

FIG. 2 is a block diagram showing the details of the general control computer shown in FIG. 1.

FIG. 3 is a block diagram showing the details of the image processing path of the digital image processor shown in FIG. 1.

FIG. 4 is a block diagram showing further details of the general control computer shown in FIG. 1.

FIG. 5 is a block diagram showing further details of the image processing modules used in the digital image processor shown in FIG. 1.

### DETAILED DESCRIPTION OF THE INVENTION

The present invention relates to a digital photofinishing system that provides a means for customizing the appearance of photographic prints based on the personal preferences of an individual user. The image processing path employed by the digital photofinishing system according to the present invention includes a plurality of image processing modules that can be activated with different control parameter settings. These control parameter settings are varied to produce display materials that the user can select from. The user makes preference selections which are recorded by the digital photofinishing system and used to produce photographic prints from the user's images.

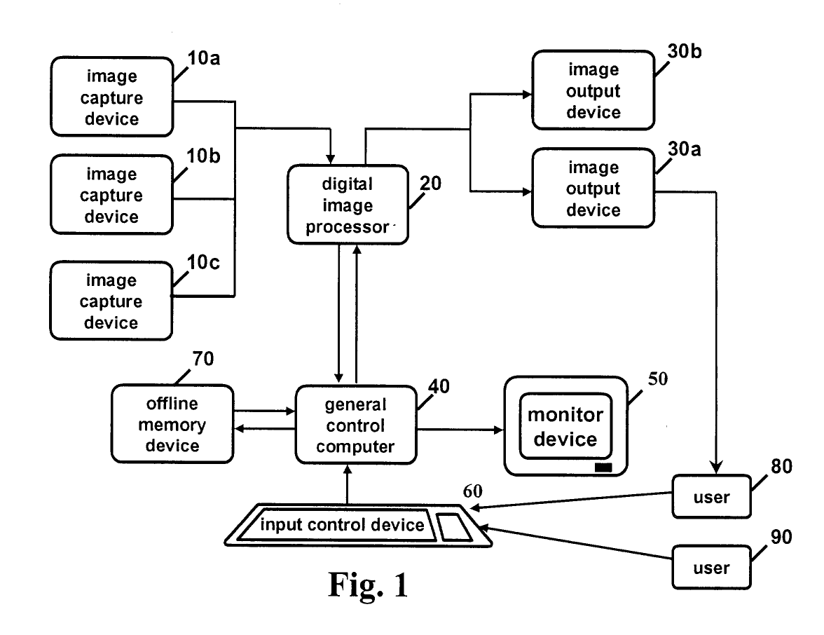

The digital photofinishing system shown in FIG. 1 includes multiple image capture devices 10a, 10b, and 10c, a digital image processor 20, and multiple image output devices 30a and 30b. The digital photofinishing system can include a monitor device 50 and an input control device 60, such as a keyboard. For example, the image capture device 10a may be a photographic film transparency scanner for generating a digital image from a photographic film transparency. The digital image processor 20 provides the means for processing the digital images to produce enhanced digital images. These enhanced digital images are received by an image output device 30a, such as a digital printer that produces photographic prints or a display that produces softcopy images. The digital image processor 20 processes an input digital image to produce an output digital image that has been enhanced in some manner and prepared for the output device 30a. The general control computer 40 receives information from, and transmits information to, the digital image processor 20 that affects the manner in which digital images are processed. An offline memory device 70 is also connected to the general control computer 40 and can be used for the purposes of storing and receiving information. The monitor device 50 is connected to the general control computer 40, which allows the operator of the digital photofinishing system to monitor the system activity.

A user 80 (an individual person or persons) views the processed images produced by one or more of the output devices 30a, makes selections as to personal preference, and enters the selections via the input control device 60. A user 90 (another individual person or persons) submits a set of digital images to be processed by the digital photofinishing system and enters information to the digital photofinishing system via the input control device 60.

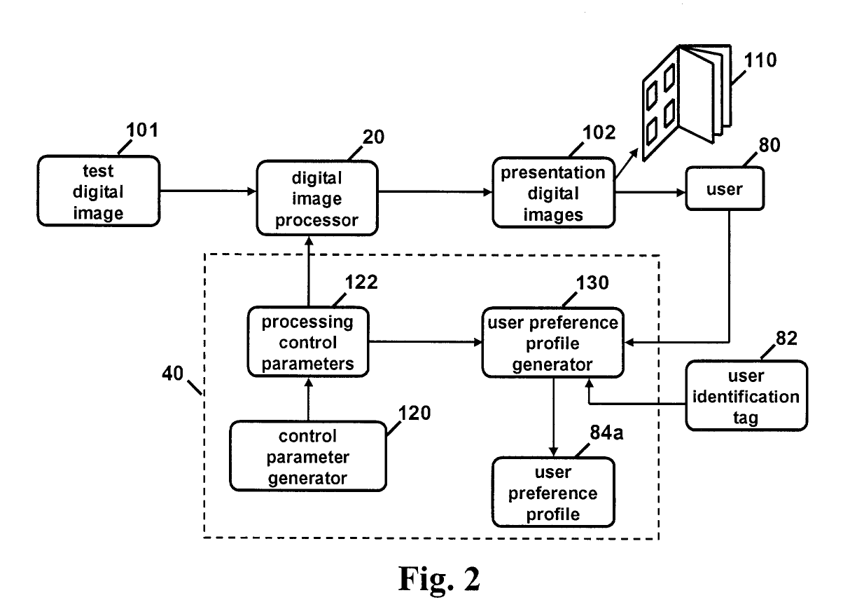

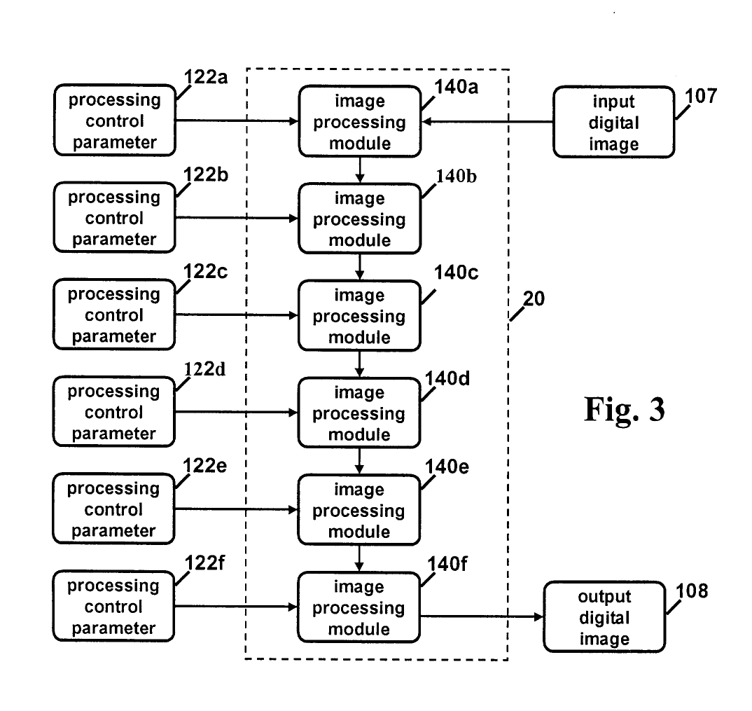

The details of the interactions of the blocks shown in FIG. 1 are shown in more detail in FIG. 2. The digital image processor 20 includes a plurality of image processing modules, each module having been designed to enhance the appearance of the processed digital images. The individual image processing modules included in the digital image processor 20 are controlled by at least one processing control parameter 122. The collection of the plurality of image processing modules and their associated processing control parameters constitutes a digital processing path (as further shown in FIG. 3) which when applied to an input digital image produces an output digital image. In the preferred embodiment, a set of processing control parameters 122 is produced by the control parameter generator 120. The digital image processor 20 receives a set of test digital images 101 which have been prepared as examples of images for which typical users express varied opinions. Examples of subject matter included in the test digital images 101 are portrait scenes, landscape scenes, flash scenes, bright sunny day scenes, sunset scenes, etc. The digital image processor 20 uses the set of processing control parameters 122 to vary the processing effects of the image processing modules, which are applied to the test digital images 101 to produce a set of presentation digital images 102. A presentation digital image 102 is the result of processing one of the test digital images 101 with the image processing modules included in the digital image processor 20 with a particular configuration of the processing control parameters 122.

The presentation digital images 102 are received by the image output device 30a, which produces a viewable image. The preferred embodiment of the present invention uses a digital printer as the image output device 30a due to its high image quality. As an alternative embodiment, the present invention s uses an electronic display device for the image output device 30a. Viewing the presentation digital images 102 on an electronic display device allows an alternative embodiment of the present invention to be used with the user 80 remote from the digital photofinishing system. The user can be at home, at a kiosk, or connected wirelessly via an internet connection. Both the electronic display device used by this alternative embodiment and the photographic prints used by the preferred embodiment are examples of different display media that allow the user to view and select from the presentation digital images 102.

The presentation digital images 102 represent different image renditions, i.e., different possible image looks that vary in one or more image quality characteristics that are made available to the user 80 via the digital photofinishing system. Thus each presentation digital image 102 represents an image rendition that could be applied to the user's personal images. The details of the available image renditions that the present invention can make available to a user 80 are given herein below. Generally, image renditions differ from one another typically in contrast, color, or the treatment of spatial detail.

The user 80 views the presentation digital images 102 as prepared by the image output device 30a and makes selections as to the user's preferences. The user preference profile generator 130 receives the selections made by the user 80 along with a user identification tag 82. The present invention uses the user's personal name as the user identification tag 82; however, other forms of unique information could be used to equivalent effect, such as the user's social security number. The important aspect of the user identification tag 82 is that it must allow the digital photofinishing system to uniquely identify the user's preferences. The user preference profile generator 130 also receives the processing control parameters 122 that relate to both the individual image processing modules included in the digital image processor 20 and the user's preference selections. The user preference profile generator 130 produces a user preference profile 84a which includes the user's user identification tag 82 and the processing control parameters relating to the user's selections. Other users perform the same task of viewing images, making selections, and entering the information into the general computer 40. Thus the digital photofinishing system records and stores in a data base a plurality of user preference profiles 84a that relate to the visual preferences of users.

In a preferred embodiment, the photographic prints produced with the presentation digital images 102 are assembled into a preference brochure 110. On each page of the preference brochure the user 80 is presented with two or more prints from which a single choice of preference must be made. The prints on each page are numbered as 1, 2, etc. The user 80 records his or her selections by indicating the number of the preferred print on a user preference form. The user preference form is then handed to the digital photofinishing system operator and entered into the general computer 40 or the user can enter the information directly. Table 1 is an example of a user preference form.

TABLE 1

| | George Washington |
|---|---|
| user | Selection: |
| Page 1 (1, 2, 3, 4, 5) | 3 |
| Page 2 (1, 2, 3, 4, 5) | 4 |
| Page 3 (1, 2, 3) | 1 |
| Page 4 (1, 2) | 2 |
| Page 5 (1, 2, 3, 4) | 4 |
| Page 6 (1, 2, 3, 4) | 2 |

As can be seen in table 1, the pages of the preference brochure do not need to have the same number of prints.

In an alternative embodiment of the present invention, the photographic prints produced with the presentation digital images 102 are assembled on poster boards to be displayed, i.e., a large sheet of material to which the photographic prints are attached. This method allows for a greater assortment of prints to be displayed and viewed simultaneously. Also a consideration is the fact that more than one person can easily view the poster boards at a time.

In another alternative embodiment of the present invention, the enhanced digital images derived from the test digital images are displayed on an electronic display device. The user makes selections by clicking with an input control device on the preferred image and the system software records the user selections to produce an electronic version of the user preference form. With this embodiment, the user can use the digital photofinishing system while connected via a remote computer connection.

In a still further alternative embodiment of the present invention, a preference brochure is printed and mailed to the user. The user then connects to the digital photofinishing system via a remote computer connection and enters his or her preference selections into a software program. The software program displays diagrams with rectangles representing the layout of images pertaining to each page of the preference brochure. The user makes selections by clicking with an input control device on the corresponding rectangles. With this embodiment, while the user can still make use of the digital photofinishing system while connected via a remote computer, he or she can rely on the photographic prints of the preference brochure to visualize the effects. This is particularly useful for photographic prints relating to sharpness and noise attributes since image structure-related image quality attributes are sometimes not well reproduced with electronic display devices.

The image processing path of the digital image processor 20 shown in FIGS. 1 and 2 is shown in more detail in FIG. 3. The digital image processor 20 includes a plurality of image processing modules 140a, 140b, 140c, 140d, 140e, and 140f, which collectively comprise an image processing path. Each image processing module has one or more corresponding processing control parameters shown by 122a, 122b, 122c, 122d, 122e, and 122f, respectively. The first image processing module 140a receives the input digital images 107 one at a time. For each input digital image 107, the image processing module 140a processes the input digital image 107 and produces a modified digital image. Image processing module 140b receives the modified digital image from image processing module 140a and modifies it further. The processing continues with the succession of image processing modules until the last image processing module, shown as image processing module 140f, produces an output digital image 108.

The control parameter generator 120 shown in FIG. 2 is configured such that the permutations of photographic prints that appear on a given page of the preference brochure corresponds to image processing variations relating to a single image processing module. For example, the print examples on page one of the preference brochure are produced by setting the values of control parameters 122b, 122c, 122d, 122e, and 122f to the digital photofinishing system default values and varying the value of processing control parameter 122a through a range of numerical values. Each of the photographic print examples on page one of the preference brochure therefore relates to a different effect achievable with different values of the processing control parameter 122a. Similarly, the print examples on page two of the preference brochure are produced by setting the values of control parameters 122a, 122c, 122d, 122e, and 122f to the digital photofinishing system default values and varying the value of processing control parameter 122b through a range of numerical values. Hence each of the photographic print examples on page two of the preference brochure therefore relates to a different effect achievable with different values of the processing control parameter 122b. Thus each page of the preference brochure relates to the effects achievable with different values of a different image processing module.

As described above, the user preference profile 84a includes the selection preferences made by the user 80, each of which is a particular permutation of a processing control parameter 122. Table 2 shows an example user preference profile 84a that corresponds to the user preference form shown in Table 1.

TABLE 2

| User identification tag: | George Washington |
|---|---|
| Processing control parameter | Value of processing control parameter |
| 122a | permutation value 3 |
| 122b | permutation value 4 |
| 122c | permutation value 1 |
| 122d | permutation value 2 |
| 122e | permutation value 4 |
| 122f | permutation value 2 |

The permutation values indicated in Table 2 represent the individual values for the processing control values 122a, 122b, 122c, 122d, 122e, and 122f that were selected by the user 80 to generate the photographic prints.

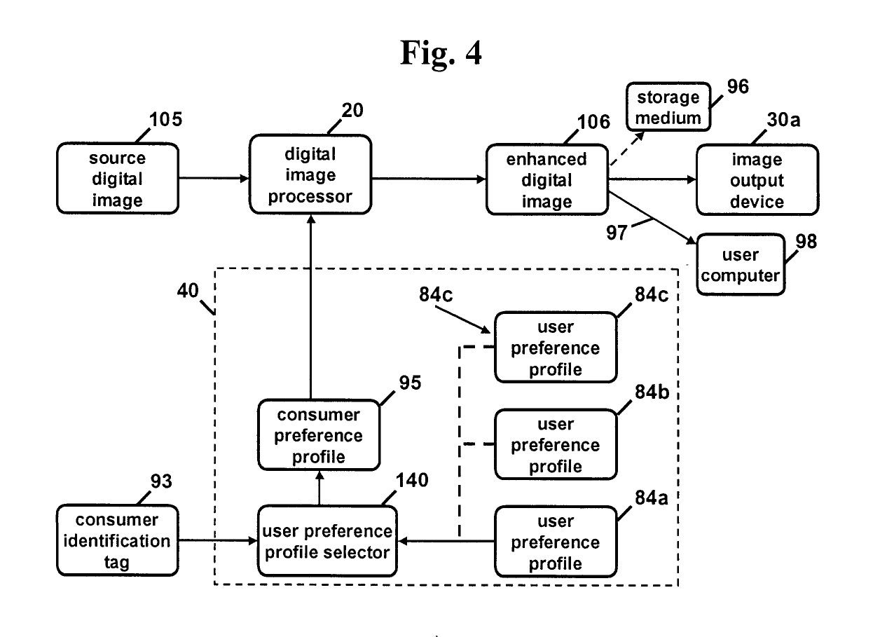

As shown in FIG. 4, the present invention uses a data base 84 of recorded user preference profiles to process digital images 105 received by a particular user according to the particular user's preferences. Referring to FIG. 4, the general control computer 40 stores the data base 84 of user preference profiles as indicated by the user preference profile blocks 84a, 84b, and 84c. These user preference profiles have been previously generated using the method described above. A user 90 of the digital photofinishing system provides the system with his or her user identification tag 93 which should be the same or nearly the same as the user identification tag 82 that the user 90 provided when he or she filled out a user preference form. A user preference profile selector 140 receives the user identification tag 93 and uses it to select the user preference profile associated with the user 90 from the data base 84 of user preference profiles. The user's user preference profile 84a is selected by comparing the received user identification tag 93 with the user identification tags 82 of all the user preference profiles in the data base. When the user preference profile selector 140 finds a match, it retrieves the user's preference profile and assigns it to the user preference profile 95.

The digital image processor 20 also receives a set of source digital images 105 from the user 90, and an indication, e.g., to the operator of the digital photofinishing system, of the quantity and the size of photographic prints to be made from the source digital images 105. The digital image processor 20 receives the user preference profile 95, which indicates the user's preferences, and processes the set of source digital images 105 using the processing control parameters 122 from the user preference profile 95 to generate a set of enhanced digital images 106. The enhanced digital images 106 are then received by the image output device 30a which produces a set of photographic prints. The user 90 receives the photographic prints and provides payment to the digital photofinishing operator.

In an alternative embodiment of the present invention, the enhanced digital images 106 are stored on a storage medium 96 such as a floppy disk or compact optical disk. For this embodiment, the user 90 has the option of choosing not to produce photographic prints.

In another alternative embodiment of the present invention, the enhanced digital images 106 are made available to the user 90 via a computer internet connection 97. For this embodiment, the user 90 has the option of choosing not to produce photographic prints. Instead, the user 90 pays for the service of access to the set of enhanced digital images 106. The user 90 can down load the enhanced digital images 106 from the general control computer 40 via a wired or wireless internet connection to the user's computer 98.

In still another alternative embodiment of the present invention, the user 90 receives a software implementation of the digital image processor 20 and general control processor 40 that can be executed on the user's computer 98. In this embodiment the user 90 makes payment, e.g., using a credit transaction over the internet connection 97, to the digital photofinishing system for the privilege to use the software implementation on the user's computer 98. In this implementation, the user 90 produces a set of enhanced digital images 106 from a set of source digital images 105. The set of enhanced digital images 106 can be used to make photographic prints on a digital printer. However, the user 90 can transmit the set of enhanced digital images 106 to the photofinishing system, where photographic prints can be made using the image output device 30a. For this embodiment of the present invention, the processing of the source digital images 105 is performed on the user's computer 98 instead of the digital image processor 20. The user 90 can be charged less than the normal payment rate for this embodiment since the digital photofinishing system required less in the way of system resources to produce the photographic prints.

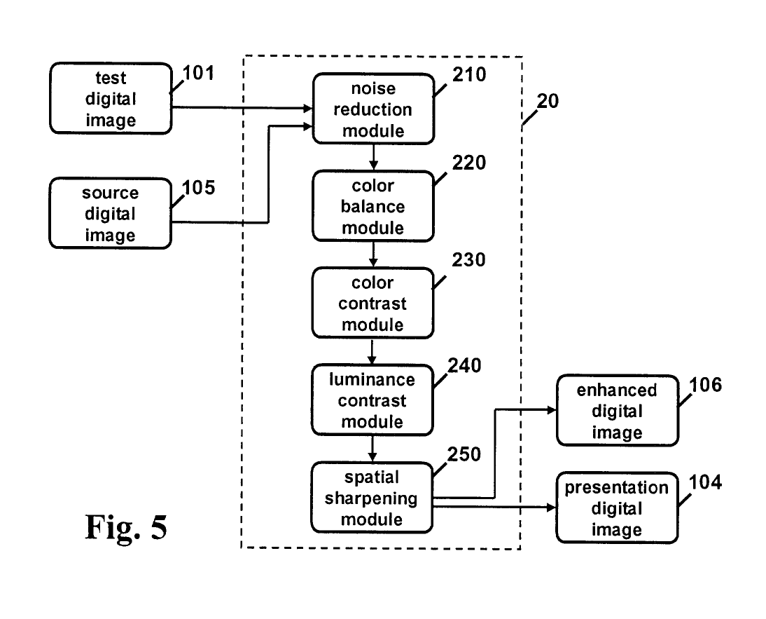

The digital image processor 20 employed by the present invention includes a variety of image processing modules that can customize the image quality of the resultant photographic prints produced. In particular, as shown in FIG. 5, the present invention includes a noise reduction module 210, a color balance module 220, a color contrast module 230, a luminance contrast module 240, and a spatial sharpening module 250. Each image processing module receives a digital image, modifies the pixel values of the image, and passes the modified digital image to the next image processing module in the sequence. While the image processing modules shown in FIG. 5 have a specific sequential order, it is possible to use the same image processing modules in a different sequential order and still achieve good results. However, experimentation has shown that the best position for the noise reduction module 210 is at the beginning of the sequence of image processing modules. This is mainly due to the fact that the best results are obtained when the noise is removed from a digital signal (image) before it is enhanced for contrast due to the fact that the contrast enhancement modules can amplify the existing noise. Similarly, the best position for the spatial sharpening module 250 is at the end of the sequence of image processing modules.

For each image processing module, the processing control parameter(s) are varied over a numerical range such that the resulting photographic prints differ from one another in approximately equal perceptual increments. That is, for each image processing module, the series of photographic prints produced by varying the corresponding processing control parameter (when ordered sequentially with respect to perceptual degree of effect) should be perceived as equally noticeable changes. Thus for the example described above and depicted in Table 1, the photographic prints resulting from the first and second permutation value of processing control parameter 122a (page 1) should appear to most observers to be approximately as different as the photographic prints resulting from the second and third permutation value of processing control parameter 122a, and so on for the other processing control parameters

The present invention uses digital images comprised of one or more digital image channels. Each digital image channel is comprised of a two-dimensional array of pixels. Each pixel value relates to the amount of light received by an imaging device corresponding to the geometrical domain of the pixel. For color imaging applications, a digital image will typically comprise red, green, and blue digital image channels. Other configurations can also be practiced, e.g. cyan, magenta, and yellow digital image channels. For monochrome applications, the digital image comprises one digital image channel. Although the present invention describes a digital image channel as a two dimensional array of pixel values arranged by rows and columns, those skilled in the art will recognize that the present invention can be applied to mosaic (non-rectilinear) arrays with equal effect.

The present invention uses a noise reduction module 210 which employs a modified version of the Sigma filter, as described by Jong-Sen Lee in the journal article Digital Image Smoothing and the Sigma Filter, Computer Vision, Graphics, and Image Processing Vol. 24, p. 255-269, 1983. The values of the pixels contained in a sampled local region, n by n pixels, where n denotes the length (number) of pixels in either the row or column direction, are compared with the value of the pixel of interest, e.g., a center pixel. Each pixel in the sampled local region is given a weighting factor of one or zero based on the absolute difference between the value of the pixel of interest and the local region pixel value. If the absolute value of the pixel value difference is less than or equal to a threshold ε, the weighting factor is set to one. Otherwise, the weighting factor is set to zero. The numerical constant E is set to two times the expected noise standard deviation. Mathematically the expression for the calculation of the noise reduced pixel value is given as equation (1)

$${q}_{mn} = {\sum }_{ij} {a}_{ij} {p}_{ij} / {\sum }_{ij} {a}_{ij} and \\ {a}_{ij} = 1 if \vert {p}_{ij} - {p}_{mn} \vert <= ϵ \\ {a}_{ij} = 0 if \vert {p}_{ij} - {p}_{mn} \vert > ϵ \qquad ( 1 )$$

where pᵢⱼ represents the ij^{th} pixel contained in the sampled local region, pₘₙ represents the value of the pixel of interest located at row m and column n, aᵢⱼ represents a weighting factor, and qₘₙ represents the noise reduced pixel value. Typically, a rectangular sampling region centered about the center pixel is used with the indices i and j varied to sample the local pixel values.

The threshold E parameter is given by equation (2), as follows:

ε=Sfacσₙ (2)

where σₙ represents the noise standard deviation of the source image. The calculation of the noise reduced pixel value qₘₙ as the division of the two sums is then calculated. The parameter Sfac is the processing control parameter that is used to vary the degree of noise reduction. The present invention uses values of 1.25, 1.50, 1.75, 2.00, 2.25, and 2.50 as values to vary the effects possible with the noise reduction module 210. The resulting presentation digital images 102 are noticeably different to most observers. Experimentation has found that the system default value (optimum value) for the parameter Sfac is 1.75.

The color balance module 220 used by the present invention has the effect of imparting an overall color cast to digital images. The present invention processes digital images in a logarithmic pixel value domain, i.e. the pixel values bear a logarithmic relationship to the original scene intensities from which the pixel values are derived. Therefore, a numerical constant added to the pixel values will result in an overall color cast change when the processed digital images are viewed on an image output device.

The input digital images to the color balance module 220 are in a red, green, and blue representation, i.e., they include a red, green, and blue digital image channel. The color balance module 220 converts the input digital image into a luminance-chrominance representation wherein the following matrix is applied to the red, green, blue pixel data resulting in three digital image channels, a luminance digital image channel (L), a green-magenta (GM) digital image channel, and an illuminant (ILL) digital image channel. The color matrix transformation relating the input and output pixel values is as follows (equation (3)):

$$\begin{matrix}{L}_{mn} = 0.333 {R}_{mn} + 0.333 {G}_{mn} + 0.333 {B}_{mn} \\ {GM}_{mn} = - 0.25 {R}_{mn} + 0.50 {G}_{mn} - 0.25 {B}_{mn} \\ {ILL}_{mn} = - 0.50 {R}_{mn} + 0.50 {B}_{mn}\end{matrix} \qquad ( 3 )$$

where Rₘₙ, Gₘₙ, and Bₘₙ refer to the pixel values corresponding to the red, green, and blue digital image channels located at the m^{th} row and n^{th} column and Lₘₙ, GMₘₙ, and ILLₘₙ refer to the processed pixel of the luminance, green-magenta, and illuminant digital image channels respectively. Those skilled in the art will recognize that the exact values used for coefficients in the luminance/chrominance color matrix transformation can be altered and still yield substantially the same effect.

The processing control parameter for the color balance module 220 is illₒ which relates to the illuminant (ILL) digital image channel. The processing control parameter illₒ changes the overall color balance of the processed images in the “warm-cool” axis of color space. Positive values for the illₒ parameter will cause the processed images to be “cooler” looking, i.e., having an overall color cast that is more toward the blue-cyan color than the original. Conversely, negative values for the illₒ parameter will cause the processed images to be “warmer” looking, i.e., having an overall color cast that is more toward the red-yellow color than the original. The color balance module modifies the digital image pixel data using equation (4)

ILL′ₘₙ=ILLₘₙ+illₒ (4)

where ILLₘₙ represents the input illuminant digital image channel pixel value and ILL′ₘₙ represents the processed illuminant digital image channel pixel value. The system default value for the processing control parameter illₒ is 0.0. The present invention uses positive and negative values for illₒ to span a range of effects including “warm” and “cool” photographic prints. The actual numerical values for the parameter illₒ depend on the computer software implementation. However, the present invention sets different values for illₒ to correspond to just noticeable changes in the resultant photographic prints, i.e., each of the viewed representations of the resulting presentation digital images 102 should be discernibly different to most observers.

The color contrast module 230 receives the processed digital image from the color balance module 220. The processing control parameter for the color contrast module 230 is represented by a variable γ_{c}. The color contrast module 230 modifies the pixel values of the luminance-chrominance representation by multiplying the green-magenta and illuminant digital image channel pixel values by the variable γ_{c} as in equations (5):

GM′ₘₙ=GMₘₙγ_{c}

ILL′ₘₙ=ILLₘₙγ_{c} (5)

where GM′ₘₙ and ILL′ₘₙ represent the processed pixel values, and GMₘₙ and ILLₘₙ represent the input pixel values to the color contrast module 230. The system default value for the variable γ_{c} is set to 1.0. The present invention uses values 0.8, 0.9, 1.0, 1.1, 1.2, 1.3, and 1.4 for the processing control variable γ_{c}. With these values for the variable γ_{c}, most observers will notice differences between all of photographic prints made with the processed digital images. The present invention uses an asymmetric set of values about the system default value for the processing control parameter since some users prefer highly boosted color contrast (corresponding to higher values of the variable γ_{c}) while other users prefer a more subtle rendition.

The luminance contrast module 240 receives the processed digital image from the color contrast module 220. The processing control parameter for the luminance contrast module 240 is represented by a variable γ_{b}. The luminance contrast module 240 modifies the pixel values of the luminance-chrominance representation by multiplying the luminance digital image channel pixel values by the variable γ_{b} as equation (6):

L′ₘₙ=Lₘₙγ_{b} (6)

where L′ₘₙ represents the processed pixel values and Lₘₙ represents the input pixel values to the luminance contrast module 240. The system default value for the variable γ_{b} is set to 1.0. The present invention uses values 0.8, 0.9, 1.0, 1. 1, and 1.2 for the processing control variable γ_{b}. With these values for the variable γ_{b}, most observers will notice differences between all of photographic prints made with the processed digital images. The present invention uses a symmetric set of values about the system default value for the processing control parameter since users appear to be evenly split between preferring images of high contrast to images of low contrast.

The spatial sharpening module 250 receives the processed digital image from the luminance contrast module 240. The processing control parameter for the spatial sharpening module 250 is represented by a variable γₛ. The present invention uses a form of unsharp masking to achieve a range of spatial sharpening effects. The luminance digital image channel is spatially filtered with a low-pass Gaussian filter with the standard deviation parameter of the Gaussian filter set to correspond to 2.5 pixels. The low-pass filtered component (lp) of the luminance digital image channel is subtracted from the luminance digital image channel yielding a high-pass component (hp) as in equation (7):

hpₘₙ=Lₘₙ−lpₘₙ (7)

Changes to the spatial detail of the processed digital images is imparted by multiplying the high-pass component values by the process control variable γₛ as in equation (8):

L′ₘₙ=hpₘₙδₛ+lpₘₙ (8)

where L′ₘₙ represents the processed pixel values of the spatial sharpening module 250. The system default value for the variable γₛ is set to 1.2 which amplifies the level of spatial detail. The optimum system default value is application specific and, in particular, depends on the spatial imaging characteristics of the digital printer used. The present invention uses values 1.0, 1.1, 1.2, 1.3, and 1.4 for the processing control variable γₛ. With these values for the variable γₛ, most observers will notice differences between all of photographic prints made with the processed digital images.

The optimum values for the processing control parameters, from a user preference perspective, can depend on the physical size of the photographic prints. Typical photographic print sizes include 3×5, 4×6, 5×7, 8×12, 11×14, and 16×20 where the numbers represent print dimensions in inches. In one embodiment of the present invention, a preference brochure is produced for each size photographic print. The user can make selections as to preference using the preference brochure that relates to the size of photographic prints that he or she typically desires. However, users are encouraged to fill out a user preference form for each size of photographic prints. For this embodiment of the present invention, an enlargement identification tag is recorded with the user preference form and consequently with the user preference profile 84a. Thus additional sets of processing control parameters 122 are recorded within the user preference profile 84a, i.e., one set of processing control parameters 122 for each size of photographic print. When the user orders photographic prints from a set of source digital images 105, the user also specifies the size of the photographic prints desired. If the user's user preference profile contains information relating to the different size photographic prints specified, the digital photofinishing system will use the corresponding set of processing control parameters 122 within the user preference profile 84a uniquely for each size of photographic print requested. Thus, the present invention provides a means for customizing the image quality of photographic prints made from digital images based on the user preference profile 84a and the size of the photographic print requested.

The optimum values for the processing control parameters can also depend on the source of the digital images. For example, a user can request photographic prints from a digital camera, from still image frames from a video camera, from a photographic film transparency, or from a photographic print.

The image structure, i.e., the noise and sharpness characteristics, of images derived from these different sources can be quite different. To accommodate user preferences that may be different for different sources of digital images, in another embodiment of the present invention, a preference brochure is produced for each source of digital images. Although the preferred embodiment of the present invention uses a pre-printed preference brochure 110, in this alternative embodiment the user 80 can supply the digital photofinishing system with the test images 101 necessary to generate the preference brochure 110. For this alternative embodiment, the user preference profile 84a records a source type identification tag that uniquely identifies the source of the digital images for which the user is making preference selections.

Thus additional sets of processing control parameters 122 are recorded within the user preference profile 84a, i.e., one set of processing control parameters 122 for each source of the digital images. When the user orders photographic prints from a set of source digital images 105, the user also specifies the source type identification tag associated with the source digital images 105. If the user's user preference profile contains information relating to the source type identification tag specified, the digital photofinishing system will use the corresponding set of processing control parameters 122 within the user preference profile 84a uniquely for each source type. Thus the present invention provides a means for customizing the image quality of photographic prints made from digital images based on the user preference profile 84a and the source of the digital images 105.

While a single user preference profile provides a means of customizing the image rendition for a particular user, some users desire a further level of customization. For example, a user may have family members that have significantly difference preferences. For some users, preference depends on the photographed subject matter. For example, a user may prefer that landscape scenes be processed with boosted color contrast for emphasis. The same user may prefer a much more subtle color contrast for a portrait scene in order to de-emphasize the red color in flesh tones.

In an alternative embodiment of the present invention, a user of the digital photofinishing system is encouraged to fill out more than one user preference form. On each user preference form there is a reserved field, a user rendition tag, that allows the user to supply a word or phrase that uniquely identifies the individual user preference form. For example, a user can give a first user preference form the user rendition tag of “scenic” and a second user preference form the user rendition tag of “portraits”. The digital photofinishing system creates a unique set of processing control parameters relating to each user preference form. Thus, additional sets of processing control parameters 122 are recorded within the user preference profile 84a, i.e., one set of processing control parameters 122 for each user preference form. The next time the user becomes a user providing payment for services, as a user he or she supplies to the digital photofinishing system the user rendition tag, along with the user identification tag and the source digital images. The digital photofinishing system selects the user preference profile based on the user identification tag as described above, and further selects the corresponding set of processing control parameters relating to the user rendition tag. Thus, a user of the digital photofinishing system is provided with a further level of customization at the point of sale. Additionally, if user desires, a user rendition tag can be supplied with each individual source digital image to be processed.

The invention has been described in detail with particular reference to certain preferred embodiments thereof, but it will be understood that variations and modifications can be effected within the spirit and scope of the invention.

Parts List

10a image capture device

10b image capture device

10c image capture device

20 digital image processor

30a image output device

30b image output device

40 general control computer

50 monitor device

60 input control device

70 offline memory device

80 user

82 user identification tag

84a user preference profile

84b user preference profile

84c user preference profile

90 user

93 user identification tag

95 user preference profile

96 storage medium

97 internet connection

98 user computer

101 test digital image

102 presentation digital image

105 source digital image

106 enhanced digital image

107 input digital image

108 output digital image

110 preference brochure

120 control parameter generator

122a processing control parameter

122b processing control parameter

122c processing control parameter

122d processing control parameter

122e processing control parameter

122f processing control parameter

130 user preference profile generator

140a image processing module

140b image processing module

140c image processing module

140d image processing module

140e image processing module

140f image processing module

210 noise reduction module

220 color balance module

230 color contrast module

240 luminance contrast module

250 spatial sharpening module

What is claimed is:

1. A method for processing a digital image in order to provide an enhanced digital image, said method comprising the steps of:
a) providing an image processing path including a plurality of image processing modules designed to enhance the appearance of the digital image, wherein the processing effect of each image processing module is controlled by one or more processing control parameters;
b) using the image processing path to process a test image;
c) generating a plurality of available image renditions from the test image by varying one or more of the processing control parameters to control the image processing path of the test image;
d) presenting the plurality of available image renditions to the user for viewing and selection by the user, whereby the selection of a particular image rendition determines the selection of a particular value of one or more processing control parameters that relate to a preference of the user;
e) generating a user preference profile by storing the selected values of the processing control parameters relating to the preference of the user; and
f) processing the digital image according to a user preference by using the user preference profile to customize the image processing path and to thereby produce an enhanced digital image from the digital image.

2. The method as claimed in claim 1 wherein step t) comprises:
g) receiving a source digital image from the user; and
h) processing the source digital image through the image processing path to generate an enhanced digital image, using the user preference profile to determine the values of the processing control parameters.

3. The method as claimed in claim 1 wherein the plurality of available image renditions presented to the user in step d) is presented on a display device.

4. The method as claimed in claim 1 wherein the plurality of available image renditions presented to the user in step d) is presented on a hard copy print.

5. The method as claimed in claim 4 wherein the hard copy print is presented in the form of a brochure showing the renditions side-by-side in an ordered relationship.

6. The method as claimed in claim 1 wherein the step c) of generating a plurality of available image renditions from a test image further includes the steps of i) selecting one of the processing control parameters and ii) using a plurality of values for the selected processing control parameter to generate the plurality of available image renditions.

7. The method as claimed in claim 6 wherein the values of the selected processing control parameters are chosen to produce image renditions in approximately equal perceptual increments.

8. The method as claimed in claim 6 further including the repetition of steps i) through ii) for other processing control parameters.

9. The method as claimed in claim 1 further including the steps of recording as part of the user preference profile a user identification tag uniquely identifying the user.

10. The method as claimed in claim 9 wherein the plurality of available image renditions in step d) are offered to a plurality of users, said method further comprising the steps of:
storing all the user preference profiles and the user identification tags in a data base;
receiving a particular user identification tag from a current user with the source digital image; and
using the particular user identification tag to identify the user preference profile of the current user from the data base.

11. The method as claimed in claim 1, further comprising the step of printing the enhanced digital image.

12. The method as claimed in claim 2, wherein the source digital image is derived from a photographic film transparency.

13. The method as claimed in claim 2, wherein the source digital image is derived from a digital camera.

14. The method as claimed in claim 2, wherein the source digital image is derived from video camera.

15. The method as claimed in claim 1, wherein the step d) of presenting the plurality of available image renditions to the user for viewing and selection by the user comprises displaying the plurality of image renditions to the user in a preference brochure, thereby permitting the user to select a desired image rendition from the displayed image renditions prior to viewing the enhanced digital image.

16. The method as claimed in claim 1, wherein the step d) of presenting the plurality of available image renditions to the user for viewing and selection by the user comprises displaying the plurality of image renditions to the user on a poster board, thereby permitting the user to select a desired image rendition from the displayed image renditions prior to viewing the enhanced digital image.

17. The method as claimed in claim 1 wherein the plurality of image processing modules of the image processing path are employed in a predetermined sequence.

18. The method as claimed in claim 1 wherein one of the image processing modules employs noise reduction processing to remove noise from the source digital image.

19. The method as claimed in claim 1 wherein one of the image processing modules employs image detail processing to enhance the spatial detail of the source digital image.

20. The method as claimed in claim 1 wherein one of the image processing modules employs color balance processing to enhance the color balance characteristics of the source digital image.

21. The method as claimed in claim 1 wherein one of the image processing modules employs contrast processing to enhance the contrast characteristics of the source digital image.

22. The method as claimed in claim 1 wherein one of the image processing modules employs color contrast processing to enhance the color contrast characteristics of the source digital image.

23. The method as claimed in claim 1 further including the repetition of steps c) through e) for test images derived from two or more different imaging devices that may be used by the same user and recording as part of the user preference profile a source type identification tag identifying the type of imaging device from which the test digital image was derived.

24. The method as claimed in claim 23 further comprising the steps of receiving a particular source type identification tag relating to the type of imaging device from which a particular source digital image was derived, and using the particular source type identification tag to select the processing control parameters from the user preference profile which relate to the same type of imaging device to generate the enhanced digital image.

25. The method as claimed in claim 1 further including the repetition of steps c) through e) wherein each plurality of available image renditions is presented to the user in a different physical size and recording as part of the user preference profile an enlargement identification tag identifying the physical size of the presented available image renditions.

26. The method as claimed in claim 25 further comprising the steps of receiving a particular enlargement identification tag relating to the physical size of prints to be made from the source digital images; and using the particular enlargement identification tag to select the processing control parameters from the user preference profile to generate the enhance digital image.

27. A computer storage medium having instructions stored therein for causing a computer to perform the method of claim 1.

28. A user-interactive digital photofinishing method for processing one or more digital images in order to provide one or more enhanced digital images, said method comprising the steps of:
a) providing an image processing path including a plurality of image processing modules designed to enhance the appearance of the digital images, wherein the processing effect of each image processing module is controlled by a processing control parameter;
b) providing a particular configuration of the processing control parameters to control the processing effect of the image processing modules in the image processing path in an ordered manner,
c) selecting one of the image processing modules;
d) generating a plurality of available image renditions from a test image by varying the processing control parameter for the selected image processing module in the image processing path of the test image, wherein the values chosen for the parameter produces image renditions in approximately equal perceptual increments;
e) presenting the plurality of available image renditions to the user for viewing and selection by the user, whereby the selection of a particular rendition determines the selection of a particular value of the processing control parameter that relates to a preference of the user;
f) generating a user preference profile by storing the selected value of the processing control parameter relating to the preference of the user;
g) repeating steps c) through f) for the processing control parameters of at least one other image processing module;
h) receiving a source digital image from the user; and
i) processing the source digital image through the image processing path to generate an enhanced digital image, using the user preference profile to determine the values of the processing control parameters.

29. The method as claimed in claim 28 wherein the plurality of available image renditions presented to the user in step e) is presented on a display device.

30. The method as claimed in claim 28 wherein the plurality of available image renditions presented to the user in step e) is presented on a hard copy print.

31. The method as claimed in claim 30 wherein the hard copy print is presented in the form of a brochure showing the renditions side-by-side in an ordered sequence.

32. The method as claimed in claim 28 further including the steps of recording as part of the user preference profile a user identification tag uniquely identifying the user.

33. The method as claimed in claim 32 wherein the plurality of available image renditions in step d) are offered to a plurality of users, said method further comprising the steps of:
storing all the user preference profiles and the user identification tags in a data base;
receiving a particular user identification tag from a current user with the source digital image; and
using the particular user identification tag to identify the user preference profile of the current user from the data base.

34. The method as claimed in claim 28 wherein the plurality of image processing modules of the image processing path are employed in a predetermined sequence.

35. The method as claimed in claim 28 wherein one of the image processing modules employs noise reduction processing to remove noise from the source digital image.

36. The method as claimed in claim 35 wherein the plurality of image processing modules of the image processing path are employed in a predetermined sequence with the noise reduction processing being first.

37. The method as claimed in claim 28 wherein one of the image processing modules employs image detail processing to enhance the spatial detail of the source digital image.

38. The method as claimed in claim 28 wherein one of the image processing modules employs color balance processing to enhance the color balance characteristics of the source digital image.

39. The method as claimed in claim 28 wherein one of the image processing modules employs contrast processing to enhance the contrast characteristics of the source digital image.

40. The method as claimed in claim 28 wherein one of the image processing modules employs color contrast processing to enhance the color contrast characteristics of the source digital image.

41. The method as claimed in claim 28 further including the repetition of steps d) through f) for test images derived from two or more different imaging devices that may be used by the same user and recording as part of the user preference profile a source type identification tag identifying the type of imaging device from which the test digital image was derived.

42. The method as claimed in claim 41 further comprising the steps of receiving a particular source type identification tag relating to the type of imaging device from which a particular source digital image was derived, and using the particular source type identification tag to select the processing control parameters from the user preference profile which relate to the same type of imaging device to generate the enhanced digital image.

43. The method as claimed in claim 28 further including the repetition of steps d) through f) wherein each plurality of available image renditions is presented to the user in a different physical size and recording as part of the user preference profile an enlargement identification tag identifying the physical size of the presented available image renditions.

44. The method as claimed in claim 43 further comprising the steps of receiving a particular enlargement identification tag relating to the physical size of prints to be made from the source digital images; and using the particular enlargement identification tag to select the processing control parameters from the user preference profile to generate the enhance digital image.

45. A computer storage medium having instructions stored therein for causing a computer to perform the method of claim 28.
